(19) United States
(12) Patent Application Publication
(10) Pub. No.: US 2004/0205159 A1
(43) Pub. Date: Oct. 14, 2004

(54) System and method for customer access to a server site

(76) Inventors: Teddy Christian Johnson, Issaquah, WA (US); Daniel Scott Jorgenson, San Jose, CA (US); Russell Vincent Lown, Petaluma, CA (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/403,561

(22) Filed: Mar. 31, 2003

(51) Int. Cl. G06F 15/16

(52) U.S. Cl. 709/218; 709/229

(57) ABSTRACT

The invention provides a system and method for communicating to a customer device. Briefly described, one embodiment is an access portal configured to relay communications between a customer device and a server device comprising a first access port coupled to a communication system and configured to receive a first communication directed to the access portal from the customer device, the first communication identifying the access portal with an access portal identifier and further requesting content from the server device; a processor configured to map a server device identifier to the received first communication, the server device identifier identifying the server device; and a second access port configured to transmit the first communication with the mapped server device identifier onto a high quality of service communication system such that the first communication is directed to the server device coupled to the high quality of service communication system.

### TECHNICAL FIELD

The present invention is generally related to remote web site access and, more particularly, is related to a system and method for accessing a web site via a high quality of service communication system.

### BACKGROUND

It is desirable to provide a customer with quick and convenient access to a company server site. However, customer access to a server site may be very slow when access is provided via a communication system having a low quality of service configuration. A server site may have, for example, a file transfer protocol (FTP) server, web server or the like, which allows the customer to access content and perform a desired functionality with the content. For example, the content may be a product line sold by the company. The functionality may be, in this illustrative example, providing information on a product of interest to the customer, providing a means for the customer to select a product of interest for purchase, providing a means for the customer to pay for the product, and finally providing a means for the customer to provide shipping information so that the purchased product may be shipped to the customer. Accordingly, it is desirable to provide fast response time for communications between the server site and the customer. That is, it is undesirable for the customer to experience a relatively long wait time between sending a communication to the server site and the receipt of a response from the server site. If such communications take a perceptibly long time, frustration may be experienced by the customer, even to the extent that the customer abandons their effort to purchase the product.

FIG. 1 is a block diagram of a conventional communication system 100 illustrating communication between a customer device 102 and a server device 104. The simplified system includes the server device 104 at a server site 106 and a service provider system 108. Service provider system 108 can be generally viewed as comprised of a plurality of nodes 110 connected by paths 112. Nodes 110 are circuit switching devices configured to provide connectivity between a large number of paths 112. An example of a service provider system is an internet service provider.

The service provider system 108 may have many components. For example, the communication may be transmitted over portions of the internet. Or, the communications may be transmitted over an asynchronous transfer mode (ATM) switched packet network. Accordingly, the communication system(s) used to transmit communications between the server site 106 and the customer device 102 is limited to the total amount of communication traffic, or capacity, that the individual components of the service provider system 108 are configured for.

The time between sending a communication from the customer device 102 to the server device 104, and the receipt of a response from the server device 104, is a function of the path 114 through the service provider system 108 over which the communication is transmitted.

When the service provider system 108 is not heavily loaded with other communications, the time between sending a communication from the customer device 102 to the server device 104, and the receipt of a response from the server device 104, is a relatively short time period because the service provider system 108 can provide high throughput of the communication through its network. However, when there are a sufficiently large number of other concurrently transmitted communications, the service provider system 108 will reach a point where there is a back up of the communications through some of the nodes 110 of the service provider system 108. This phenomenon is well known as traffic congestion. During periods of traffic congestion, the time between sending a communication to the server site 106 and the receipt of a response from the server site 106 can be undesirably long when communications are delayed at congested nodes 110.

When a customer contracts for service with a service provider, the customer typically agrees to be provided with a minimum throughput specified in a service level agreement (SLA). One measure of throughput is known as quality of service (QoS). In cases where the customer desires a fast service where the time between sending a communication to the server site 106 and the receipt of a response from the server site 106 is very short, the customer may contract with the service provider for a high QoS. Accordingly, during periods of traffic congestion, the customer's communications are given priority over other traffic or routed over a non-congested network. However, many customers, particularly individuals and small businesses, may not have the financial resources to pay a premium for a high QoS communication system.

A variety of techniques have been used to provide quick customer access to a company. One technique is for the company to provide duplicate server sites 116 strategically located near potential customers. For example, the company may know that customers in remote parts of the world may have slow service (low QoS) with the company's server site 106. Accordingly, the company may elect to set up a duplicate secondary server site 116 at a selected location. Accordingly, the customer accesses the secondary server site 116, having a second server device 118, such that the time between sending a communication to the second server device 118 and the receipt of a response from the second server device 118 is short.

However, many costs are incurred with maintaining a secondary server site 116. The additional second server device 118 must be purchased, installed and maintained. Operating software and content must be provided and maintained. On-site personnel required to maintain the second server device 118 (or if service is contracted for) can be expensive. For example, if an operating system error is discovered, the solution must be implemented on both the server device 104 and the secondary server device 118. Similarly, content changes, such as a change in the product line or a change in the presentation of the product, must be separately implemented at both the server device 104 and the second server device 118. Accordingly, the customer device 102 avoids communicating through some congested nodes 110, as illustrated by path 120 between the customer device 102 and the second server device 118.

Another prior art technique to provide quick customer access is generic router encapsulation (GRE) tunneling that employs the Point-to-Point Protocol (PPP—defined and documented by the Internet Engineering Task Force in RFC 1171). With GRE tunneling, PPP packet information is encapsulated into internet protocol (IP) datagrams for transmission over IP-based networks. Accordingly, communications are transmitted in IP datagrams containing PPP packets. The IP datagram is created using a modified version of the GRE protocol.

FIG. 1 further illustrates a GRE tunneling solution 122 for communications between the customer device 102 and the company's server device 104. The customer device 102 is configured to send and receive packet based communications over the illustrated path 124. These communications are typically communicated from the customer device 102 to the GRE tunnel system 126 over a first service provider system 128.

The GRE tunnel system 126 includes at least three components. The first component is a server 130 configured to receive the packet based communications from the service provider system 128 such that the received packets generated by the customer device 102 are encapsulated into datagrams or the like. The GRE tunnel system 126 includes the transmission system 132 over which the datagrams are quickly transmitted to a second server 134. This second server 134 is configured to strip out the packet based communication from the received encapsulated datagram, and further configured to transmit the received packet communication to a second service provider system 136. The second service provider system 136 then transmits the communication to the company's server device 104. Return communications from the company's server device 104 to the customer device 102 are similarly transmitted along path 124 in a reverse direction.

Use of the GRE tunnel system 126, during times of traffic congestion, can be much quicker because one or more congested nodes 110 are bypassed by the GRE tunnel system 126. Accordingly, the GRE tunnel system 126 increases the perceived quality of service for the customer. However, such a GRE tunnel system 126 may be complex, involve multiple parties, and may incur various costs for the service of the multiple systems employed.

The above-described GRE tunneling solution 122 utilizes three separate systems, the first service provider system 128, the GRE tunnel system 126 and the second service provider system 136. For convenience, the service provider systems 108, 128 and 136 were illustrated as separate systems. However, any of the service provider systems 108, 128 and 136 could be part of one another.

### SUMMARY

The present invention provides a system and method for communicating to a customer device. Briefly described, one embodiment is an access portal configured to relay communications between a customer device and a server device comprising a first access port coupled to a communication system and configured to receive a first communication directed to the access portal from the customer device, the first communication identifying the access portal with an access portal identifier and further requesting content from the server device; a processor configured to map a server device identifier to the received first communication, the server device identifier identifying the server device; and a second access port configured to transmit the first communication with the mapped server device identifier onto a high quality of service communication system such that the first communication is directed to the server device coupled to the high quality of service communication system.

Another embodiment is a system that communicates with a customer device comprising an access portal coupled to a communication system, the access portal configured to receive a first communication from the customer device over the communication system, the first communication directed to the access portal based upon an access portal identifier identifying the access portal; a server device where content resides, the server device identified by a server device identifier; and a high quality of service (QoS) communication system communicatively coupling the access portal and the server device so that the server device identifier is mapped to the first communication such that when the access portal transmits the first communication onto the high quality of service communication system, the first communication is directed to the server device.

### BRIEF DESCRIPTION OF THE DRAWINGS

The invention can be better understood with reference to the following drawings. The elements of the drawings are not necessarily to scale relative to each other, emphasis instead being placed upon clearly illustrating the principles of the invention.

FIG. 1 is a block diagram of a conventional communication system illustrating communication between a company's server device and a customer device.

FIG. 2 is a block diagram illustrating an embodiment of the present invention, a portal access system, employing an access portal to provide connectivity between a customer device and the company's server device via a high quality of service communication system.

FIG. 3 is a block diagram illustrating an embodiment of an access portal.

FIG. 4 is a block diagram illustrating an embodiment of the access portal configured to communicate with two exemplary types of server devices.

FIG. 5 is a flowchart illustrating an embodiment of a process, according to the present invention, for providing access between the customer device and the server device.

FIG. 6 is a block diagram illustrating another embodiment of a portal access system in accordance with the present invention communicatively coupled to a communication system.

### DETAILED DESCRIPTION

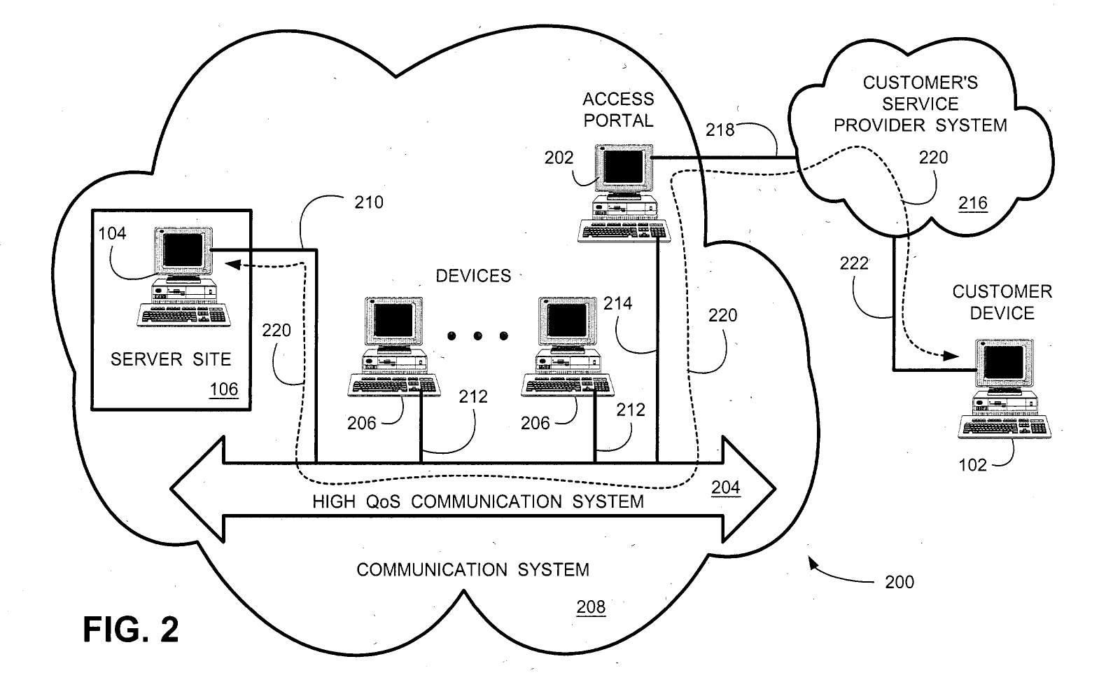

FIG. 2 is a block diagram illustrating an embodiment of the present invention, a portal access system 200, employing an access portal 202 to provide connectivity between a customer device 102 and the company's server device 104 via a high quality of service (QoS) communication system 204. The access portal 202, high QoS communication system 204, and a plurality of devices 206 are illustrated for convenience, as residing in the company's communication system 208. In an alternative embodiment, the customer device 102 and the server device 104 are commonly owned.

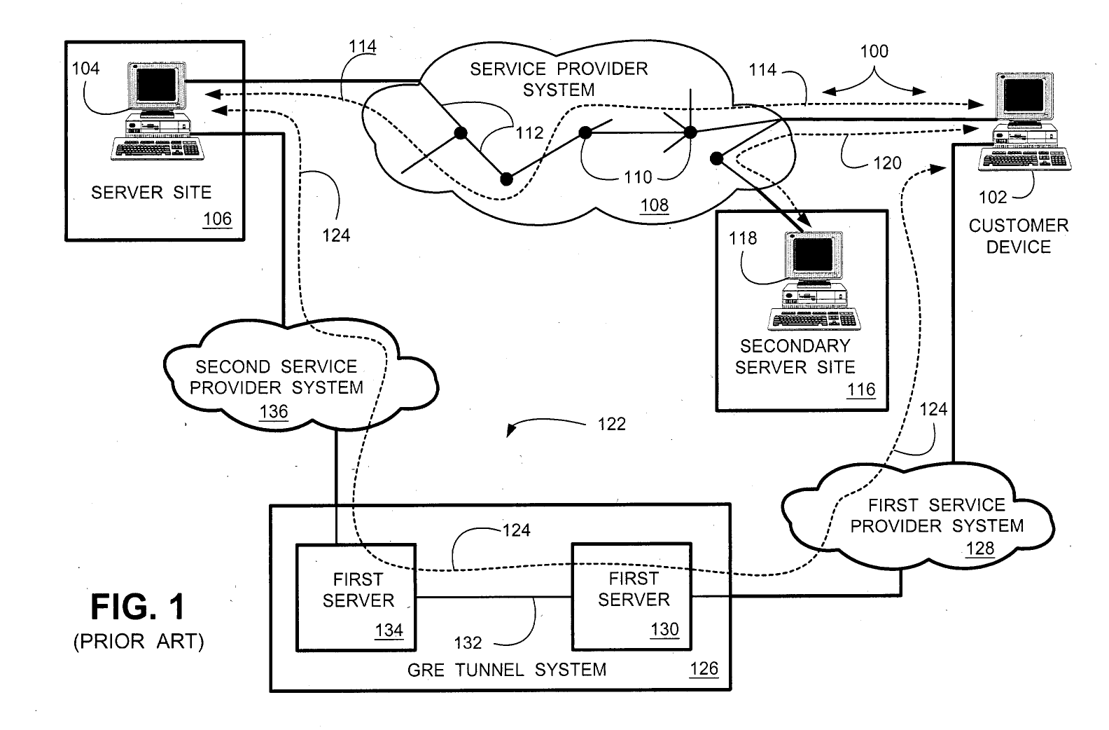

The company's communication system 208 is configured to provide connectivity between the company's server devices. Typically, the company is a large corporation that may have work sites distributed over a wide geographic area, even globally. Because of the importance of expedient and secure communications, the company has implemented a dedicated communication system 208 so that the plurality of devices 206 are communicatively coupled together. That is, the company has implemented a dedicated communication system 208 to avoid the congested nodes 110 (FIG. 1) typically encountered on a service provider system 108 that is used by the general public and/or other organizations.

Since the server device 104, residing in the company's server site 106, is periodically accessed by at least one of the plurality of devices 206, the server device 104 is coupled to the high QoS communication system 204 via connection 210. Thus, when programs or content in the server device 104 are accessed by one of the devices 206, coupled to the high QoS communication system 204 via connections 212, fast response times are achieved because the communications are transmitted over the company's high QoS communication system 204.

In some embodiments, the high QoS communication system 204 is owned, operated and maintained by the company. The high QoS communication system 204 may be comprised of specialized high speed communication systems, such as, but not limited to, fiber optic networks, satellites, radio frequency (RF) systems, packet based hard wire systems, microwave, power line carrier or combination systems. In other embodiments, the high QoS communication system 204 may be a portion of a service provider system that has contracted with the company to provide a high quality of service standard in accordance with a service level agreement (SLA). Embodiments of the present invention may be implemented on any suitable communication system that provides a high QoS to the company.

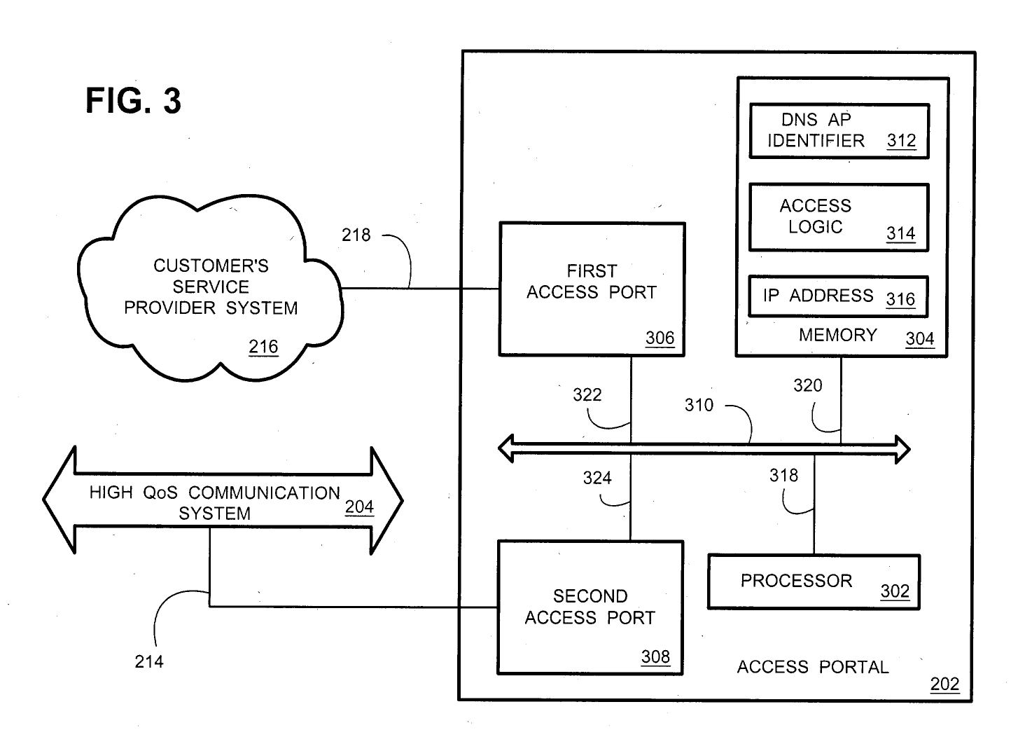

Embodiments of the portal access system 200 employ an access portal 202 that is coupled to the high QoS communication system 204, via connection 214. Access portal 202 is also coupled to the customer's service provider system 216, via connection 218. When the customer desires access to the company's server device 104, communications from the customer device 102 are directed to the access portal 202, as illustrated by path 220. Communications are directed to the access portal 202 by including an access portal identifier in the communication. The access portal identifier may be the DNS AP identifier 312 and/or the IP address 316 (FIG. 3).

Access portal 202 relays the communications over the company's high QoS communication system 204 to the server device 104, as illustrated by path 220, thereby avoiding the congested nodes 110 (FIG. 1). Return communications from the company's server device 104 to the customer device 102 are similarly transmitted along path 220 in a reverse direction.

Customer device 102 is understood to be coupled to the customer's service provider system 216 via connection 222. In one-embodiment, the customer's service provider system is an internet service provider. Accordingly, access portal 202 is configured to couple to and communicate with the customer's service provider system 216. By selectively locating the access portal 202, many if not all congested nodes 110 are avoided. Furthermore, a plurality of different customers may gain improved access to the server device 104 by directing communications to the company's access portal 202.

Access portal 202, in one embodiment is a simple processing device, such as a personal computer (PC) or the like, that is configured to communicate with the server device 104 via the high QoS communication system 204 and the customer's service provider system 216. In other embodiments, the access portal 202 is a specially configured and/or dedicated device providing the functionality of the present invention as described herein. In some embodiments, the access portal 202 is a public-domain application proxy program, such as, but not limited to, a plug-gw (gateway), running on a generic unix or linux system. By implementing the proxy functionality as a applications program, it is less likely to need modifications when the system has patches applied or when the operating system is upgraded to a different version.

As a simplified illustrative example, the company may have facilities in the United States (U.S.) and facilities in Europe. A European customer accessing the server device 104, residing in the server site 106 located in the U.S., in the absence of the present invention, may experience undesirable long time delays between sending a communication to the server device 104 and the receipt of a response when communications are delayed at congested nodes 110 (FIG. 1). With the present invention instead, the company's high QoS communication system 204 provides communication between the server device 104 located in the U.S. and the access portal 202 located in Europe. Thus, the European customer perceives that quick access is provided. Furthermore, the customer may not be aware of this process of relaying communications by the portal access system 200.

FIG. 3 is a block diagram illustrating an embodiment of an access portal 202. Access portal 202 comprises a processor 302, a memory 304, a first access port 306 configured to communicatively couple to the customer's communication system 216, a second access port 308 configured to communicatively couple to the company's high QoS communication system 204, and communication bus 310. Memory 304 comprises a domain name service (DNS) access portal (AP) identifier 312, access logic 314 and an internet protocol (IP) address 316.

For convenience, processor 302, memory 304, first port 306 and second port 308 are communicatively coupled to communication bus 310 via connections 318, 320, 322 and 324, respectively. In alternative embodiments of an access portal 202, the above-described components are connectively coupled in a different manner than illustrated in FIG. 3. For example, one or more of the above-described components may be directly coupled to each other or may be coupled to each other via intermediary components (not shown).

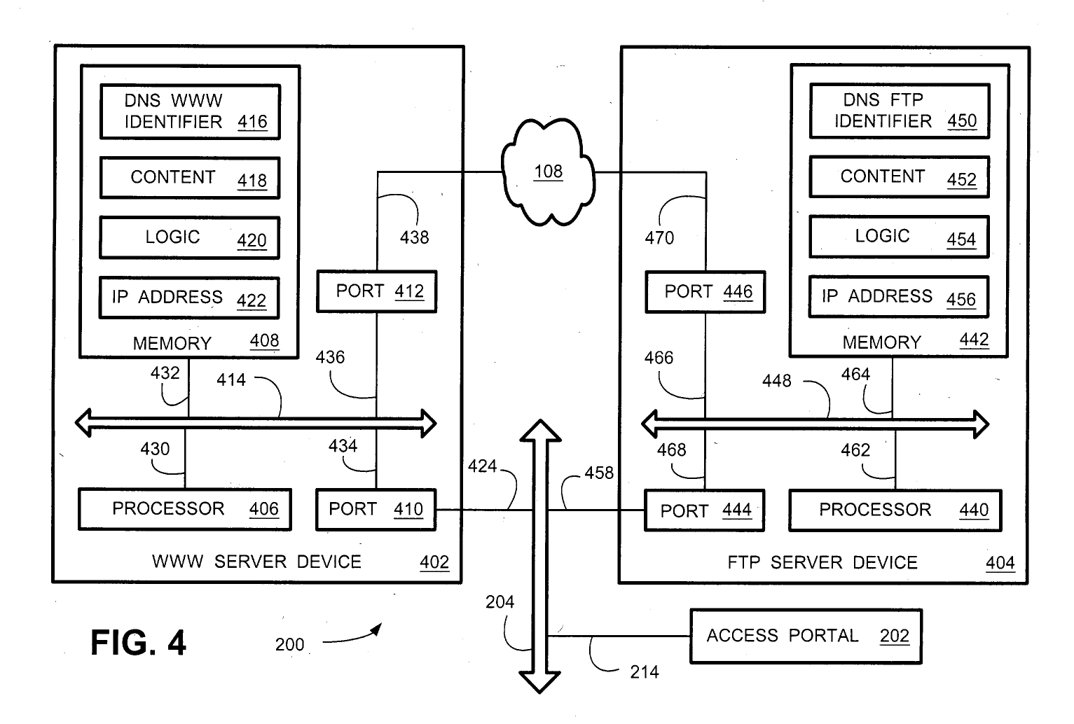

FIG. 4 is a block diagram illustrating an embodiment of the access portal 202 configured to communicate with two exemplary types of server devices 402 and 404. The first exemplary company's server device is a server configured to provide content formatted for world wide web (WWW) communications typically provided when a customer uses a personal computer or the like to access a company's web page. For convenience, this first server device is denoted as a WWW server device 402. The second exemplary server device is a device configured to provide content formatted for file transfer protocol (FTP) communications typically provided when a customer uses a PC, telephone, personal device assistant (PDA) or other device to access file based content. For convenience, this second server device is denoted as a FTP server device 404.

WWW server device 402 comprises a processor 406, a memory 408, and a plurality of access ports 410 and 412 configured to communicatively couple to the company's high QoS communication system 204, and communication bus 414. Memory 408 comprises a domain name service DNS WWW identifier 416, content 418, logic 420 and an IP address 422. DNS WWW identifier 416 and/or IP address 422 are server device identifiers that identify the WWW server device 402.

Port 410 is communicatively coupled to the company's high QoS communication system 204 via connection 424. Processor 406, memory 408 and ports 410 and 412 are communicatively coupled to communication bus 414 via connections 430, 432, 434 and 436, respectively. Some server devices 402 may be optionally coupled to a service provider system 108 (see also FIG. 1), via connection 438, for convenience.

FTP server device 404 comprises a processor 440, a memory 442, and a plurality of access ports 444 and 446 configured to communicatively couple to the company's high QoS communication system 204, and communication bus 448. Memory 442 comprises a domain name service DNS FTP identifier 450, content 452, logic 454 and an IP address 456. DNS FTP identifier 450 and/or IP address 456 are server device identifiers that identify the FTP server device 404.

Port 444 is communicatively coupled to the company's high QoS communication system 204 via connection 458. Processor 440, memory 442 and ports 444 and 446 are communicatively coupled to communication bus 448 via connections 462, 464, 466 and 468, respectively. Some FTP server devices 408 may be optionally coupled to a service provider system 108 (see also FIG. 1), via connection 470, for convenience.

In alternative embodiments of WWW server device 402 and FTP server device 404, the above-described components may be connectively coupled in a different manner than illustrated in FIG. 4. For example, one or more of the above-described components may be directly coupled to each other or may be coupled to each other via intermediary components (not shown).

Furthermore, the WWW server device 402 and the FTP server device 404 were illustrated as separate devices, separately accessible by embodiments of the access portal 202. Access portal 202 may be further configured in accordance with the present invention to relay communications from/to a customer device 102 to a combination device having both functionalities of the WWW server device 402 and the FTP server device 404. Such a combination device is configured to provide both WWW and FTP formatted content. Furthermore, embodiments of access portal 202 may be configured to relay communications from/to a customer device 102 to a plurality of WWW server devices 402, and/or a plurality of FTP server devices 404, and/or a plurality of WWW/FTP combination server devices, and/or another device configured to provide content based upon another format.

To illustrate operation of embodiments of the access portal 202, a simplified illustrative example is described hereinbelow. The DNS WWW identifier 416 having an indicia of “www.company.com” and/or an IP address 422 having an indicia of “98.76.54.1” are designated so that the WWW server device 402 is uniquely identified. Similarly, the DNS FTP identifier 450 having an indicia of “ftp.company.com” and/or an IP address 456 having an indicia of “98.76.54.2” are designated so that the FTP server device 404 is uniquely identified. Accordingly, communications can be directed to the WWW server device 402 from one of the plurality of the company's devices 206 (FIG. 2) or from an access portal 202 by identifying the communication with a “www.company.com” indicia and/or the “98.76.54.1” indicia. Similarly, communications can be directed to the FTP server device 404 from one of the plurality of devices 206 or from an access portal 202 by identifying the communication with a “ftp.company.com” indicia and/or the “98.76.54.2” indicia. The communications are transmitted over any suitable communication system to which the WWW server device 402 or the FTP server device 404 is coupled to. That is, communications are transmitted over the company's high QoS communication system 204 or over another service provider system (assuming that the WWW server device 402 or the FTP server device 404 is communicatively coupled to the other service provider system).

The DNS AP identifier 312 having an indicia of “www-remote.company.com” and/or IP address 316 having an indicia of “98.76.54.3” is designated so that the access portal 202 is uniquely identified for WWW based communications. Access logic is configured to receive WWW based communications from the customer device 102, via the customer's service provider system 216 (FIG. 2), map or otherwise correlate the received communication to the “www.company.com” indicia, and then cause the access portal 202 to transmit the communication onto the company's high QoS communication system 204 such that the communication is received by the WWW server device 402.

Responses directed back to the customer device 102 are formatted by logic 420 to identify the customer device 102, and are further formatted with the indicia of “www-remote.company.com” and/or the indicia of “98.76.54.3” to direct the response to the access portal 202 when the response is transmitted over the company's high QoS communication system 204.

In one embodiment, link information embedded into the WWW format response, such as, but not limited to, hyper text markup language (HTML) links or uniform resource locators (URLs), are modified or replaced by logic 420, residing in the WWW server device 402, to correspond to the identifier associated with the access portal 202. Accordingly, if a customer viewing the response actuates a link embedded in the response, the associated communication is directed to the access portal 202.

When the response is received by the access portal 202, the response is mapped or otherwise correlated to the customer device 102 and transmitted onto the customer's service provider system 216. Accordingly, the access portal 202 relays received WWW format communications between the customer device 102 and the WWW server device 402 along the path 220 (FIG. 2).

In another embodiment, link information embedded into the WWW format response, such as, but not limited to, HTML links or URLs, are modified or replaced by logic 314 (FIG. 3), residing in the access portal 202, to correspond to the identifier associated with the access portal 202. Accordingly, if a customer viewing the response actuates a link embedded in the response, the associated communication is directed to the access portal 202.

In another embodiment, the DNS AP identifier 312 has an indicia of “ftp-remote.company.com” and/or an indicia of “98.76.54.3” is designated so that the access portal 202 is uniquely identified for FTP based communications. Access logic is configured to receive FTP based communications from the customer device 102, via the customer's service provider system 216 (FIG. 2), map the received communication to the “ftp.company.com” indicia, and then cause the access portal 202 to transmit the communication onto the company's high QoS communication system 204 such that the communication is received by the FTP server device 404.

When the response is received by the access portal 202, the response is mapped or otherwise correlated to the customer device 102 and transmitted onto the customer's service provider system 216. Accordingly, the access portal 202 relays received FTP format communications between the customer device 102 and the FTP server device 404 along the path 220.

In another embodiment, the access portal includes both the exemplary WWW indicia (www.company.com and/or 98.76.54.1) and the FTP indicia (ftp.company.com and/or 98.76.54.2) so that either WWW formatted communications or FTP based communications, respectively, are relayed to the appropriate device in accordance with the present invention. In yet another embodiment, a single indicia for the access portal is used, and the access logic 316 is configured to analyze the received communication to determine the format of the communication. Communications are then mapped accordingly. In such embodiments, a single IP address 318 indicia of “98.76.54.3” may be designated.

In the above simplified hypothetical illustrative example wherein the indices were selected to identify a specific device, it is understood that any suitable identifier or indicia may be used in accordance with the present invention to identify a specific device. Furthermore, it is understood that a plurality of access portals 202 may be located at points where connectivity to the company's high QoS communication system 204 is available. Customers are simply told, that when accessing content provided by the company, to direct their communications to a convenient access portal 202. To the customer, the access portal appears to be a server itself, located geographically near them and thus yielding good network performance. For example, the company might create an access portal in Japan for Japanese customers and name the portal www-japan.company.com. To Japanese customers it would appear as if the company created a new server site in Japan in order to improve performance for Japanese customers. In reality, www-japan.company.com is an access portal which transparently relays traffic along the company's high QoS backbone to the company's server in, for example, California. An access portal 202 selected for a customer so that the number of congested nodes between the customer device 102 and the selected access portal 202 are reduced and/or minimized.

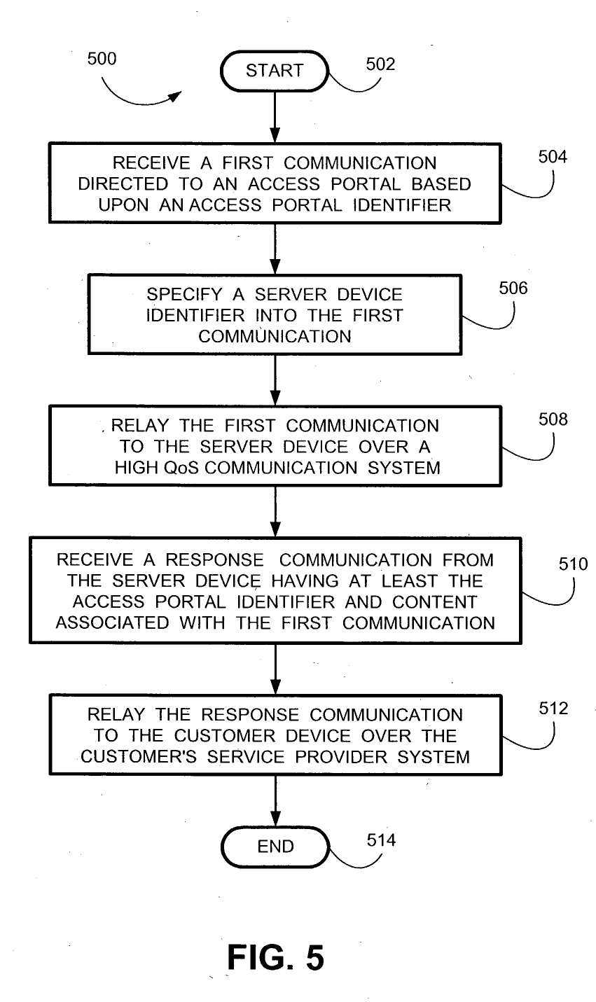

FIG. 5 is a flowchart 500 illustrating an embodiment of a process, according to the present invention, for providing access between the customer device 102 and the server 104. The flow chart 500 shows the architecture, functionality, and operation of an embodiment for implementing the access logic 314 (FIG. 3) such that communications are relayed from/to a customer device 102 to a WWW server device 402, a FTP server device 404, and/or a WWW/FTP device, as described above in accordance with the present invention. An alternative embodiment implements the logic of flow chart 500 with hardware configured as a state machine. In this regard, each block may represent a module, segment or portion of code, which comprises one or more executable instructions for implementing the specified logical function(s). It should also be noted that in some alternative implementations, the functions noted in the blocks may occur out of the order noted in FIG. 5, or may include additional functions, without departing from the functionality of the access portal 202. For example, two blocks shown in succession in FIG. 5 may in fact be substantially executed concurrently, the blocks may sometimes be executed in the reverse order, or some of the blocks may not be executed in all instances, depending upon the functionality involved, as will be further clarified hereinbelow. All such modifications and variations are intended to be included herein within the scope of the present invention.

The process begins at block 502. At block 504, a first communication from the customer device 102 is received over a customer's service provider system 216 (FIG. 2). The first communication is directed to an access portal 202 based upon an access portal identifier, such as the DNS AP identifier 312 and/or the IP address 316.

At block 506, a server device identifier associated with the server device 104 is specified for the received first communication. In one embodiment, the server device identifier, such as the DNS WWW identifier 416 and/or the IP address 422 for a WWW server device 402, or the DNS FTP identifier 450 and/or the IP address 456 for a FTP server device 402 (FIG. 4), is mapped into the first communication.

At block 508, the first communication is relayed to the server device 104 over a company's high QoS communication system 204. At block 510, a response communication from the server device 104 directed to the customer device 102 is received over the company's high QoS communication system 204 by the access portal 202. The response communication has at least content associated with the first communication and the access portal identifier. At block 512, the response communication is relayed by the access portal 202 over the customer's service provider system 216 to the customer device 102. The process ends at block 514.

Embodiments of the invention implemented in memory 454 may be implemented using any suitable computer-readable medium. In the context of this specification, a “computer-readable medium” can be any means that can store, communicate, propagate, or transport the data associated with, used by or in connection with the instruction execution system, apparatus, and/or device. The computer-readable medium can be, for example, but not limited to, an electronic, magnetic, optical, electromagnetic, infrared, or semiconductor system, apparatus, device, or propagation medium now known or later developed.

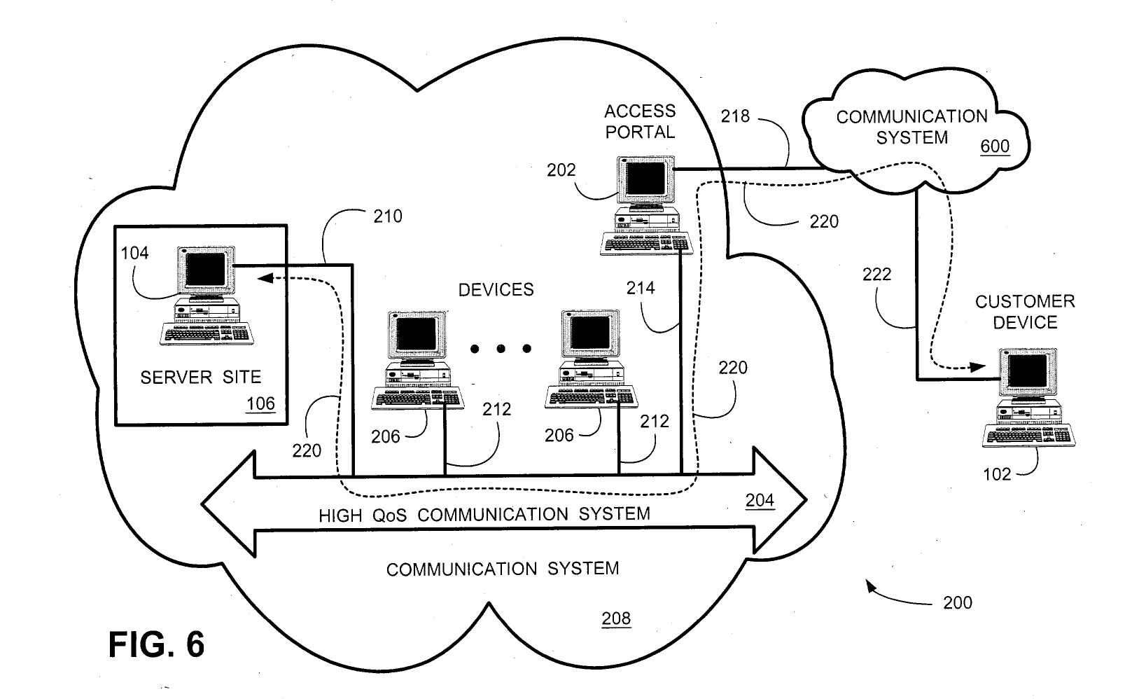

FIG. 6 is a block diagram illustrating another embodiment of a portal access system 200 in accordance with the present invention communicatively coupled to a communication system 600. In this embodiment, access portal is configured to communicatively couple to a system that the customer device 102 is coupled to. For example, the customer may be another large organization that has its own high QoS communication system. Accordingly, the access portal may be configured to couple to the customer's high QoS communication system directly or to another intermediary device of the customer. Like the embodiment illustrated in FIG. 2 and described above, access portal 202 relays the communications over the company's high QoS communication system 204 to the server device 104, as illustrated by path 220, thereby avoiding the congested nodes 110 (FIG. 1). Return communications from the company's server device 104 to the customer device 102 are similarly transmitted along path 220 in a reverse direction.

It should be emphasized that the above-described embodiments of the present invention are merely examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

Therefore, having thus described the invention, at least the following is claimed:

1. A method for communicating content between a server device and a customer device, the method comprising:
receiving a first communication from the customer device, the first communication directed to an access portal based upon an access portal identifier, and where the first communication is received over a communication system;
specifying in the received first communication a server device identifier associated with the server device; and
relaying the first communication to the server device over a high quality of service communication system.

2. The method of claim 1, further comprising mapping the server device identifier into the received first communication.

3. The method of claim 2, wherein the mapping does not alter a format of the first communication.

4. The method of claim 1, further comprising replacing the access portal identifier with the server device identifier.

5. The method of claim 1, further comprising receiving a response communication from the server device directed to the customer device over the high quality of service communication system, the response communication corresponding to the first communication, having at least content associated with the first communication, and having the access portal identifier.

6. The method of claim 5, wherein a format of the content is a file transmission protocol.

7. The method of claim 5, wherein a format of the content is a world wide web (WWW) protocol.

8. The method of claim 7, further comprising replacing at least one first link in the received response communication, the first link corresponding to the server device, with at least one second link corresponding to the access portal.

9. The method of claim 7, further comprising modifying at least one link in the received response communication, the link corresponding to the server device, using a modified link corresponding to the access portal.

10. The method of claim 5, further comprising mapping a customer device identifier into the received response communication.

11. The method of claim 5, further comprising relaying the response communication to the customer device over the customer's service provider system.

12. A system which communicates with a customer device, comprising:
an access portal coupled to a communication system, the access portal configured to receive a first communication from the customer device over the communication system, the first communication directed to the access portal based upon an access portal identifier identifying the access portal;
a server device where content resides, the server device identified by a server device identifier; and
a high quality of service communication system communicatively coupling the access portal and the server device such that the server device identifier is mapped to the first communication so that when the access portal transmits the first communication onto the high quality of service communication system, the first communication is directed to the server device.

13. The system of claim 12, wherein a response communication associated with the first communication is transmitted from the server device to the access portal over the high quality of service communication system, the response communication comprising at least the content and the access portal identifier, and wherein the response communication received by the access portal is relayed to the customer server device over the communication system.

14. The system of claim 12, further comprising a plurality of access portals configured to relay a plurality of communications between the server device and a plurality of unique customer devices over the high quality of service communication system.

15. The system of claim 12, further comprising a plurality of server devices, wherein the access portal selectively relays the received first communication to a selected one of the plurality of server devices over the high quality of service communication system.

16. An access portal configured to relay communications between a customer device and a server device, comprising:
a first access port coupled to a communication system and configured to receive a first communication directed to the access portal from the customer device, the first communication identifying the access portal with an access portal identifier and further requesting content from the server device;
a processor configured to map a server device identifier to the received first communication, the server device identifier identifying the server device; and
a second access port configured to transmit the first communication with the mapped server device identifier onto a high quality of service communication system such that the first communication is directed to the server device coupled to the high quality of service communication system.

17. The apparatus of claim 16, further comprising a memory having an access logic configured to instruct the processor so that the server device identifier is mapped to the first communication.

18. The apparatus of claim 16:
wherein the second access port is further configured to receive a response communication directed to the customer device, the response communication having the access portal identifier;
wherein the processor is further configured to map the customer device identifier to the received response communication, the customer device identifier identifying the customer device; and
wherein the first access port is further configured to transmit the response communication with the mapped customer device identifier onto the communication system such that the response communication is received by the customer device.

19. The apparatus of claim 18, further comprising a memory having an access logic configured to instruct the processor so that a customer device identifier is mapped to the first communication.

20. A system for communicating content to a customer device, comprising:
means for receiving a first communication from the customer server device, the first communication directed to an access portal, and where the first communication is received over a communication system;
means for mapping into the received first communication a server device identifier associated with a server device;
means for relaying the first communication to the server device over a high quality of service communication system, the first communication directed to the server device by the server device identifier mapped into the first communication;
means for receiving a response communication from the server device directed to the customer device over the high quality of service communication system, the response communication corresponding to the first communication and having an identifier identifying the access portal; and
means for relaying the response communication to the customer device over the communication system.

21. A computer-readable medium having a program for communicating content to a customer device, the program comprising logic configured to perform the steps of:
receiving a first communication from the customer device, the first communication directed to an access portal identified by an access portal identifier, and where the first communication is received over a service provider system;
mapping into the received first communication a server device identifier associated with a server device;
relaying the first communication to the server device over a high quality of service communication system, the first communication directed to the server device by the server device identifier mapped into the first communication;
receiving a response communication from the server device directed to the customer device over the high quality of service communication system, the response communication corresponding to the response communication and having the access portal identifier;
mapping into the received response communication a customer device identifier corresponding to the customer device; and
relaying the response communication to the customer device over the service provider system, the response communication directed to the server device by the server device identifier mapped into the response communication.
